(19) United States
(12) Patent Application Publication
(10) Pub. No.: US 2022/0024368 A1
(43) Pub. Date: Jan. 27, 2022

(54) Mobile Fluid Containment System and Method

(71) Applicant: Dale E. SMITH, Weatherford, TX (US)

(72) Inventor: Dale E. SMITH, Weatherford, TX (US)

(21) Appl. No.: 17/143,574

(22) Filed: Jan. 7, 2021

Related U.S. Application Data
(60) Provisional application No. 63/055,046, filed on Jul. 22, 2020.

(51) Int. Cl. B60P 3/22; B60G 3/22; B60G 11/27; B60G 17/052; B60G 17/015

(52) U.S. Cl. CPC B60P 3/2205; B60G 3/225; B60G 11/27; B60G 2204/4702; B60G 17/0155; B60G 2202/152; B60G 17/0525

(57) ABSTRACT

A fluid containment system comprises a frame, a tank, a rear suspension system, a front lifting assembly, a cooperative coupling mechanism adapted to couple the fluid containment system to a vehicle, and a rear lifting assembly. The front lifting assembly is adapted to lift the front of the tank. The rear lifting assembly is adapted to lift the rear of the tank. The fluid containment system comprises a working condition and a mobile condition. A lower portion of the frame rests on a surface when the mobile fluid containment system is in the working condition. The lower portion of the frame is elevated with respect to the surface when the mobile fluid containment system is in the mobile condition. The fluid containment system is adapted to be towed by the vehicle when the cooperative coupling mechanism is coupled to the vehicle and the fluid containment system is in the mobile condition.

### SPECIFICATION

This application claims the benefit of U.S. provisional patent application Ser. No. 63/055,046 filed Jul. 22, 2020, the contents of which are incorporated by reference herein in their entirety.

### BACKGROUND OF THE INVENTION

### 1. Field of the Invention

The present invention relates generally to fluid containment systems and specifically to an improved mobile fluid containment system and method for use in oil and gas fracking operations or other applications such as water storage for dust control, de-icing fluid and fuel storage at airports, and overflow storage at sewage treatment plants.

### 2. Description of the Prior Art

Hydraulic fracturing is the injection, under pressure, of water, sand, and/or other fluids within a well formation to induce fractures in a rock layer. Oil and gas drilling operators commonly use hydraulic fracturing, or “fracking” to release petroleum and natural gas well as other substances from the rock layer. The high-pressure injection creates new channels in the rock which can increase the extraction rates and ultimate recovery of fossil fuels. A hydraulic fracturing pump or “frac pump” is used to pump water, sand, gravel, acids, proprietary liquids, concrete, and other fluids, fluid mixtures, and/or other proppants (collectively referred to herein as “fracturing fluids” or “fluids”) into the well formation. The fluids pumped down the hole into the fractures keep the fractures from closing after the pressure is released.

Mobile fluid containment containers, “frac tanks”, are used to hold such fluids during drilling and fracking operations. Conventional frac tanks are relatively large steel tanks having an angled or rounded lower floor permitting the tank to be emptied. Conventional frac tanks vary in size ranging from 8,400 gallons (200 bbl) to 21,000 gallons (500 bbl). The current industry standard is the 500 bbl capacity frac tank. Because the fluid required during a drilling operation far exceeds 500 bbl, multiple frac tanks, fluidly coupled to one another, are used at the well site. Often ten or more 500 bbl frac tanks are positioned on the site pad which, undesirably, takes up a significant portion of the pad site.

While a group of larger frac tanks could reduce the overall footprint of the tanks, the primary reason for the 500 bbl tank standard relates to issues that arise when attempting to transport larger frac tanks over open roads. Conventional tanks are transported at an angle such that a front-end tank height is greater than a rear-end tank height. Because of the configuration of such prior art frac tanks and the manner in which they are transported, laws, regulations, and practical considerations prohibit the economical transport of larger sized conventional frac tanks. For example, the front-end height (“ride height”) of a conventional 500 bbl tank, when coupled to the truck or loaded on the trailer, is approximately 13′6″. A greater height would exceed practical height limitations imposed by the need to travel under certain bridges and overpasses. Thus, 500 bbl tanks are used.

Additionally, coupling conventional frac tanks to the towing vehicle can be inconvenient, time consuming, and in some cases, dangerous. Winches or cranes are typically used to lift such tanks onto either a trailer or a king-pin receiver portion of a semi-truck.

What is needed is a mobile fluid containment system and method that comprises a large capacity tank that can be easily and safely coupled to a towing vehicle and economically transported over open roads.

### SUMMARY OF THE INVENTION

The fluid containment system comprises a large capacity tank adapted for holding fluid at an oil well site to be pumped into the oil well during drilling operations or other applications such as water storage for dust control operations, de-icing fluid and fuel storage at airports, and overflow storage at sewage treatment plants. Additional applications for which the system can be used include, but are not limited to, environmental storage tanks, gas buster tanks, mud gas separators, vapor gas separation tanks, flow back tanks, hold back tanks and other applications requiring storage of liquids and/or solids.

The fluid containments system is adapted for mobile transport by, for example, a conventional and commercially available semi-truck. The fluid containment system is configured for conversion between a working condition and a mobile condition. In preferred embodiments, the fluid containment system comprises a pneumatically-actuated articulating kingpin sub-system which uses leverage to lift the tank off the ground rather than winches or cranes. In such position, the fluid containment system can easily be coupled to a king pin receiver of a conventional and commercially available semi-truck. When coupled to and transported by the semi-truck, the preferred fluid containment system conforms to applicable department of transportation standards and regulations.

The mobile fluid containment system of the preferred embodiment generally comprises a tank, a front lifting assembly, a rear lifting assembly, and a rear suspension system.

In preferred embodiments, the fluid containment system has a three-dimensional rectangular outer profile structure. The tank of the preferred embodiment is taller and longer than conventional 500 bbl tanks. The new tank provided for herein takes advantage of having storage capacity within a tongue of the tank, not available in conventional tanks due to the shape of conventional tanks and transport method requirements.

The tank of the preferred embodiment comprises an 875 bbl capacity and a usable working capacity of 800 bbls. One preferred size of the fluid containment system is nominally 8′6″ wide, 12′8″ high, and 58 feet long. These dimensions provide for ease of transport and delivery to a job site such as a drilling pad.

The tank comprises a large capacity container adapted for holding fluid at an oil well site to be pumped into an oil/gas well during drilling operations. The tank of the preferred embodiment comprises a modified rectangular configuration when viewed from a top plan view. In its cross-section and in certain embodiments, the tank is defined by a front wall, rear wall, top, floor and side walls. The front, top, and side walls are generally planar and orthogonal with one another. The back wall is parallel with the front wall. A rear portion of the fluid containment system comprises a cutout or open portion of the tank. This open portion defines inside walls, lower top portion, and angled portion of the tank. This open portion comprises a stairway comprising steps. The steps of the stairway are coupled, in the preferred embodiment, to the angled portion of the tank. The rear portion further comprises a bumper assembly comprising steps. The steps of the bumper assembly lead to the steps of the stairway. The steps of the stairway provide access to the top of the tank.

Thus, the stairway of the preferred embodiment is positioned at the rear portion of the fluid containment system. The industry standard is for tanks to comprise ladder type rungs positioned at the front of the tank. The rearward stairway positioning of the preferred embodiment provides greater safety because an operator using the stairway is away from hoses that are connected at the front of the tank.

The top and side wall comprise one or more access portions (“manways”) adapted to be sealingly closed with a hatch. When the hatch is in an open position, the access portions are adapted to permit access to an inside of the tank by a person. When in a closed position, the hatch prohibits fluid (including liquid, vapor, and/or gas) from escaping from the tank through the access portion.

The tank further comprises one or more manifold assemblies, fill lines, ball valves, pressure relief valves (PRV valves), structured and arranged to permit the fluid containment system to, generally, function, fluid dynamically, as other conventional frac tanks.

The rear portion of the fluid containment system further comprises an angled floor. This angled floor slopes upward from front to rear and provides a space for the rear suspension system to move freely between the working condition and the mobile condition.

The rear suspension system of the preferred embodiment comprises an axle assembly, wheels, and tires structured and arranged to permit the wheels and tires to rotate about the axle assembly. The rear suspension system is pivotally coupled to the tank at one or more coupling points such that the rear suspension system may be pivoted upwardly and downwardly to and between the working condition and the mobile condition. For example, when the fluid containment system is in the working condition, the rear suspension system is folded upward and substantially or wholly contained within the space such that the tank rests upon the ground. By way of further example, when in the mobile condition, portions of the tires of the rear suspension system extend below the space such that the tank is raised above the ground. Movement of the rear axle assembly in the manner described herein permits the tank to be transported in the level position. Conventional frac tanks are transported in a configuration in which the front end of the conventional frac tank is higher than the rear.

The rear lifting assembly is adapted to move the rear suspension system up and down to and between the working condition and the mobile condition.

The front lifting assembly is positioned beneath a tongue portion of the tank. The kingpin sub-system of the front lifting assembly comprises a rear arm assembly, a front arm assembly, the front arm assembly comprising a kingpin adapted to be coupled within the kingpin receiver portion of the semi-truck. The front arm assembly and rear arm assembly are coupled to one another via a support assembly. The front arm assembly is pivotally coupled to the support assembly. Airbags supplied with air or other fluid by air lines of the front lifting assembly are adapted to move the front arm assembly such that the kingpin is moved in a generally upward and downward direction. Therefore, when in the upward position, the front arm assembly, together with the kingpin, are in position for the semi-truck to move partially under the tongue portion of the tank without contacting the front lifting assembly. In such position, the kingpin can be lowered into the kingpin receiver portion of the semi-truck. With further downward movement of the front arm assembly against the kingpin receiver portion of the semi-truck, the fluid containment system is adapted be moved into the mobile condition. In such condition, the fluid containment system can easily be transported to another location. Using the front lifting assembly and rear lifting assembly, a user can adjust a ride height of the fluid containment system within certain parameters. For example, the fluid containment system of the preferred embodiment has 18″ of adjustable ride height making it suitable for lowering to get under obstacles and raising to get over obstacles.

Although the front and rear lifting assemblies of preferred embodiments comprise pneumatic systems comprising bags, the front and rear lifting assemblies need not comprise pneumatic systems. Rather, other systems known in the art can be used to raise and lower the front and rear portions of the fluid containment system. For example, hydraulic systems comprising hydraulic pumps, fluids, rams, scissor lifts, and/other lifts can be used to raise and lower portions of the fluid containment system. Other mechanical means of raising and lowering components can also be used. For example, a motorized or hand powered screw jack, scissor jack, or winch and cable system can be incorporated within the fluid containment system.

The tank floor slopes to permit essentially complete emptying of fluid from the tank either during delivery of fluid to the drilling site or if draining the tank of unused fluid as from a drain (not shown). The tank may be supported on a substantially rectangular lower frame that includes beams and other frame members welded or otherwise secured together. Front wall, rear wall, and side walls of the tank of the preferred embodiment are formed from heavy duty corrugated steel. Upright members support sides of the tank. The top of the preferred embodiment is formed from heavy steel plate. The frame may include cross-beams spaced along the length of the tank, and lengthwise or front-to-back laterally spaced beams under the tank.

A method of moving a fluid containment system is also provided. The method of a preferred embodiment comprises, the steps of providing a fluid containment system at a first location, the fluid containment system comprising a tank, a front lifting assembly, a rear lifting assembly, and a rear suspension system; providing a vehicle comprising a receiver portion adapted to receive a male portion of a hitch; moving the vehicle receiver portion proximate to the male portion of the hitch; using the front lifting assembly, coupling the male portion of the hitch to the receiver portion; using the rear lifting assembly, raising a rear portion of the tank; and using the vehicle, moving the fluid containment system from the first location to the second location.

In other embodiments, after the step of using the vehicle, moving the fluid containment system from the first location to the second location, the method further comprises the steps of: using the rear lifting assembly, lowering the rear portion of the tank; using the front lifting assembly, uncoupling the male portion of the hitch from the receiver portion; and moving the vehicle receiver portion away from the male portion of the hitch.

In preferred embodiments of the method, the fluid containment system is adapted to be moved by a conventional and commercially available semi-truck.

In preferred embodiments of the method, the front lifting assembly comprises a pneumatically-actuated articulating kingpin sub-system which uses leverage to lift the tank off the ground rather than winches or cranes.

In preferred embodiments of the method, the rear suspension system comprises an axle assembly, wheels, and tires structured and arranged to permit the wheels and tires to rotate about the axle assembly. The rear suspension system is pivotally coupled to the tank at one or more coupling points such that the rear suspension system may be pivoted upwardly and downwardly between the working condition and the mobile condition.

In an embodiment of the method, the user, using the front lifting assembly and rear lifting assembly, can selectively adjust a ride height of the fluid containment system upwardly and downwardly.

### BRIEF DESCRIPTION OF THE DRAWINGS

FIG. 1 is a right side elevation view of the mobile fluid containment system, in accordance with a preferred embodiment.

FIG. 2 is a top plan view of the mobile fluid containment system of FIG. 1.

FIG. 3 is a rear elevation view of the mobile fluid containment system of FIG. 1.

FIG. 4 is a front elevation view of the mobile fluid containment system of FIG. 1.

FIG. 5 is a side isometric view of the mobile fluid containment system coupled to a semi-truck.

FIG. 6 is a left side and front isometric view of the front lifting assembly of the mobile fluid containment system.

FIG. 7 is a rear and left side isometric view of the of the mobile fluid containment system of FIG. 1.

FIG. 8 is a right side, partial cut-away, elevation view of the mobile fluid containment system, in accordance with another embodiment (rear suspension shown in concept view only; right rear side cut-away to show stairs).

FIG. 9 is a top plan view of the mobile fluid containment system of FIG. 8.

FIG. 10 is a rear elevation view of the mobile fluid containment system of FIG. 8 (rear suspension system not shown).

FIG. 11 is a front elevation view of the mobile fluid containment system of FIG. 8.

FIG. 12 is a right side partial sectional view of the rear portion of the mobile fluid containment system taken along the line XII-XII of FIG. 10 (rear suspension shown in concept view).

### DESCRIPTION OF THE PREFERRED EMBODIMENT

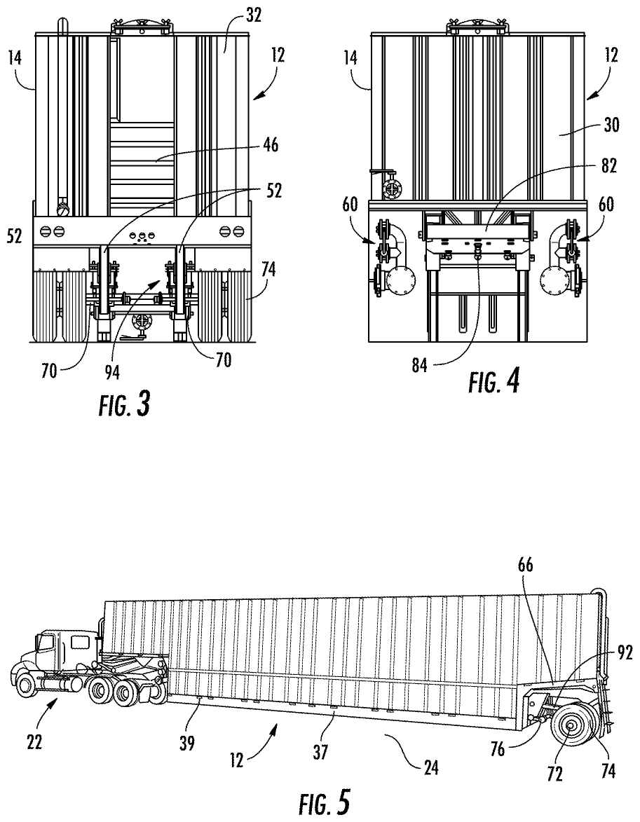

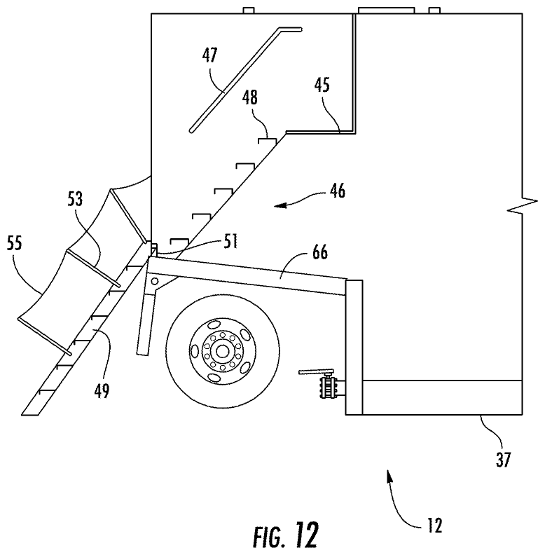

Referring to FIGS. 1-12, there is shown the mobile fluid containment system 12 in accordance with preferred embodiments. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

Referring to the figures, the mobile fluid containment system 12 of the preferred embodiment generally comprises a tank 14, a front lifting assembly 16, a rear lifting assembly 18, and a rear suspension system 20.

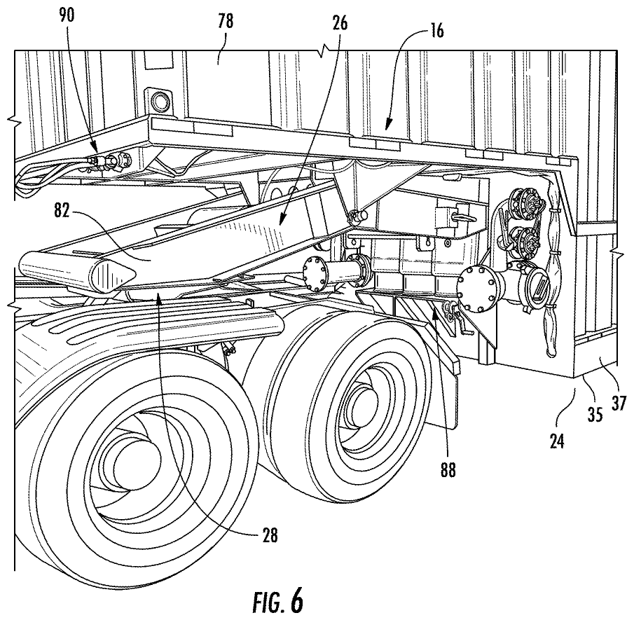

The fluid containment system 12 is adapted for mobile transport by, for example, a conventional and commercially available semi-truck 22 or other properly equipped vehicle such as a tug, a yard truck, and the like. The fluid containment system 12 is configured for conversion between a working condition (FIG. 1) and a mobile condition (FIG. 5). In preferred embodiments, the front lifting assembly 16 comprises a pneumatically-actuated articulating kingpin sub-system 26 which uses leverage to lift the tank 14 off the ground 24 rather than winches or cranes. In such position, the fluid containment system 12 can easily be coupled to a king pin receiver 28 of the semi-truck 22. When coupled to and transported by the semi-truck 22, the preferred fluid containment system 12 conforms to applicable department of transportation standards and regulations.

In preferred embodiments, the fluid containment system 12 has a three-dimensional rectangular outer profile structure. The tank 14 of the preferred embodiment is taller and longer than conventional 500 bbl tanks. The new tank 14 provided for herein takes advantage of having storage capacity within a tongue 78 of the tank 14, not available in conventional tanks due to the shape of conventional tanks and transport method requirements.

The tank 14 of the preferred embodiment comprises an 875 bbl capacity and a usable working capacity of 800 bbls. One preferred size of the fluid containment system 12 is nominally 8′6″ wide, 12′8″ high, and 58 feet long. These dimensions provide for ease of transport and delivery to a job site such as a drilling pad.

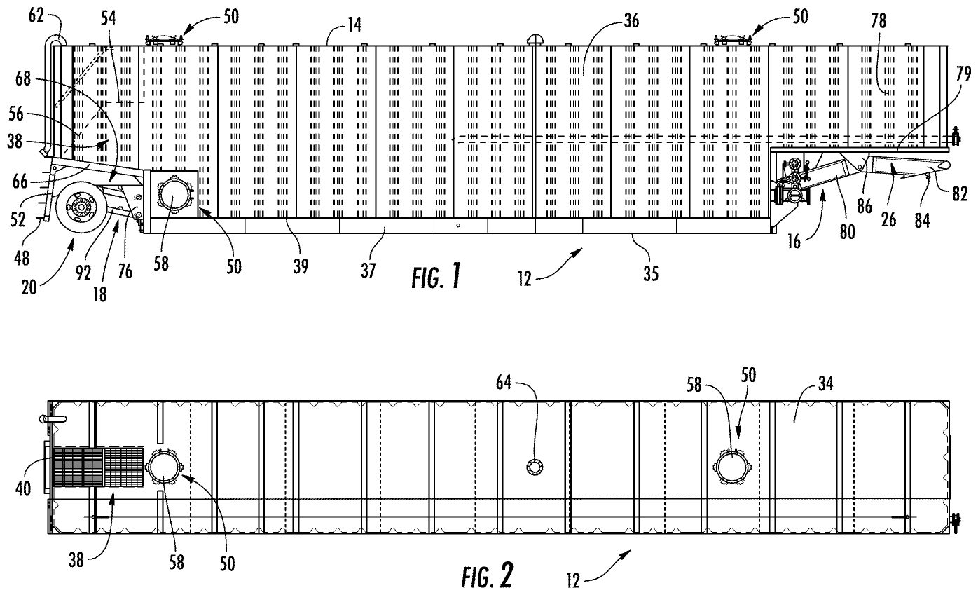

The tank 14 comprises a large capacity container adapted for holding fluid at an oil well site to be pumped into an oil/gas well during drilling operations. The tank 14 of the preferred embodiment comprises a modified rectangular configuration when viewed from a top plan view, as shown in FIG. 2. In its cross-section and in certain embodiments, the tank 14 is defined by a front wall 30, rear wall 32, top 34, lower floor 39 and side walls 36. The front 30, top 34 and side walls 36 are generally planar and orthogonal with one another. The back wall 32 is parallel with the front wall 30. A rear portion 38 of the fluid containment system 12 comprises a cutout or open portion 40 of the tank 14. As depicted in FIG. 7, this open portion 40 defines inside walls 42, 44, lower top portion 54, and angled portion 56 (FIG. 1) of the tank 14. This open portion 40 comprises a stairway 46 comprising a landing 45 and steps 48. The steps 48 of the stairway 46 are coupled, in the preferred embodiment, to the angled portion 56 of the tank 14. The rear portion 38 further comprises a bumper assembly 52 comprising steps 48. The steps 48 of the bumper assembly 52 lead to the steps 48 of the stairway 46. The steps 48 of the stairway 46 provide access to the top of the tank 14.

Thus, the stairway 46 of the preferred embodiment is positioned at the rear portion 38 of the fluid containment system 12. The industry standard is for tanks to comprise ladder type rungs positioned at the front of the tank. The rearward stairway 46 positioning of the preferred embodiment provides greater safety because an operator using the stairway 46 is away from hoses that are connected at the front of the tank 14.

Referring to FIGS. 1 and 2, the top 34 and side wall 36 comprise one or more access portions 50 (“manways”) adapted to be sealingly closed with a hatch 58. When the hatch 58 is in an open position, the access portions 50 are adapted to permit access to an inside of the tank 14 by a person. When in a closed position, the hatch 58 prohibits fluid, including, liquid, vapor and/or gas, from escaping from the tank 14 through the access portion 50. In the preferred embodiment, the hatch 58 is sealed and structured to permit lock down. In other embodiments, the hatch 58 comprises a pressure relief valve feature.

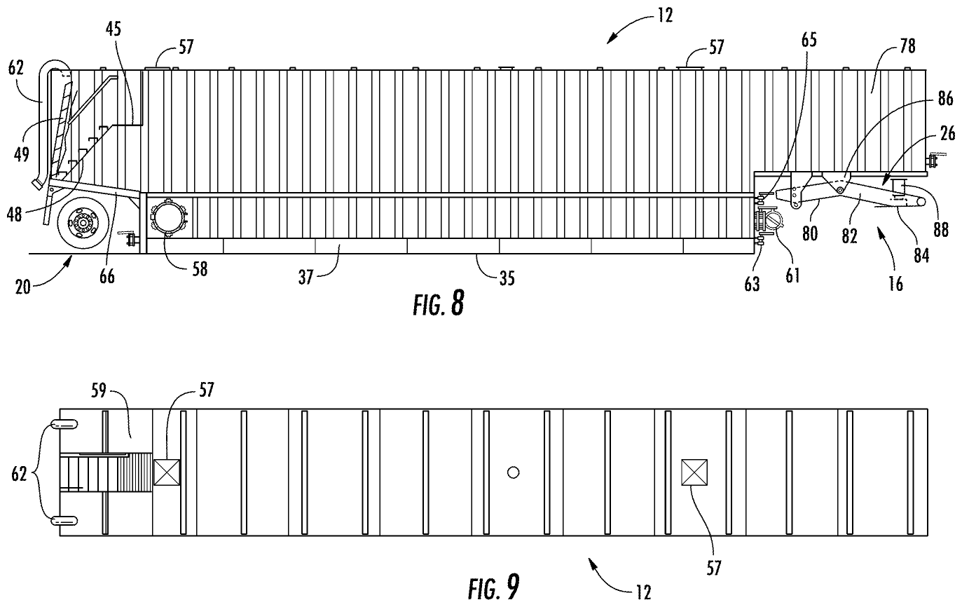

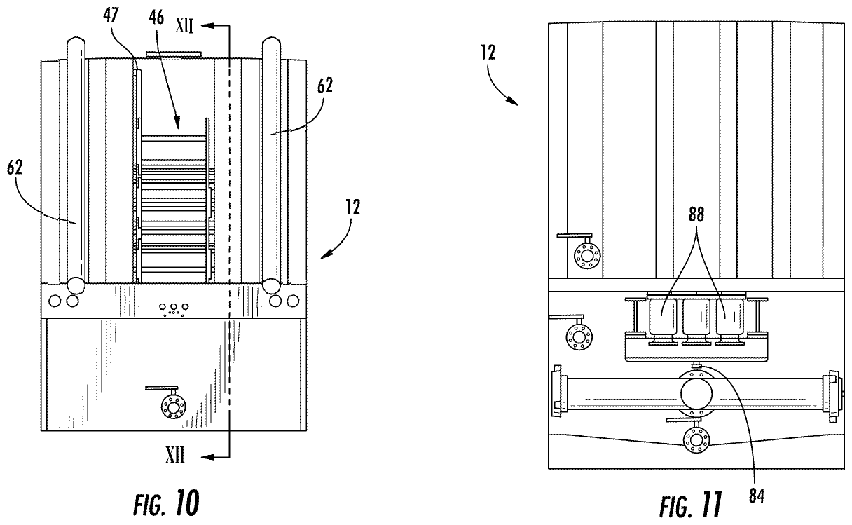

The tank 14 further comprises one or more manifold assemblies 60, fill lines 62, ball valves 59 (depicted in FIG. 9), pressure relief valves (PRV valves) 64, structured and arranged to generally permit the fluid containment system 12 to function, fluid dynamically, as other conventional frac tanks.

Referring to FIGS. 1 & 5, the rear portion 38 of the fluid containment system 12 further comprises an angled floor 66. This angled floor 66 slopes upward from front to rear and provides a space 68 for the rear suspension system 20 to move freely between the working condition and the mobile condition. The angled floor 66 also directs fluid towards the lower floor 37 which permits easy clean out.

The rear suspension system 20 of the preferred embodiment comprises an axle assembly 70, wheels 72, and tires 74 structured and arranged to permit the wheels 72 and tires 74 to rotate about the axle assembly 70. The rear suspension system 20 is pivotally coupled to the tank 14 or frame at one or more coupling points 76 such that the rear suspension system 20 may be pivoted upwardly and downwardly to and between the working condition and the mobile condition. For example, when the fluid containment system 12 is in the working condition depicted in FIG. 1, the rear suspension system 20 is folded upward and substantially or wholly contained within the space 68 such that the tank 14 rests upon the ground 24. By way of further example, when in the mobile condition depicted in FIG. 5, portions of the tires 74 of the rear suspension system 20 extend below the space 68 such that the tank is raised above the ground 24. Movement of the rear axle assembly 70 in the manner described herein permits the tank 14 to be transported in the level position depicted in FIG. 5. Conventional frac tanks are transported in a configuration in which the front end of the conventional frac tank is higher than the rear.

The rear lifting assembly 18 is adapted to move the rear suspension system 20 up and down to and between the working condition and the mobile condition. The rear lifting assembly 18 of the preferred embodiment comprises four swing arms 92 operatively coupled with two airbags 94 that lift the rear of the tank 14 off the ground 24 and are stabilized by crossmembers and the rear axle 70. This arrangement permits the rear to be lifted to an equal height as the front, permitting the tank to ride level during transportation.

Although in the preferred embodiment, the rear suspension system 20 is pivotally coupled to the tank 14 or frame 37, the rear suspension system 20 need not pivot. In some embodiments, the rear suspension system 20 is generally fixed in position such that it need not pivot downward for the system 12 to be in the mobile condition.

Referring to FIG. 1, the front lifting assembly 16 is positioned beneath a tongue portion 78 of the tank 14. The tongue portion 78 comprises a tongue floor 79. In a preferred embodiment, the tongue floor 79 is generally parallel the lower floor 39. In other embodiments, the tongue floor 79 is angled such that it slopes towards the lower floor 39. Such angle permits fluid to drain towards the lower floor 39 and promotes easy cleanout.

The kingpin sub-system 26 of the front lifting assembly 16 comprises a rear arm assembly 80, a front arm assembly 82, the front arm assembly 82 comprising a kingpin 84 adapted to be coupled within the kingpin receiver portion 28 of the semi-truck 22. The front arm assembly 82 and rear arm assembly 80 are coupled to one another via a support assembly 86. The front arm assembly 82 is pivotally coupled to the support assembly 86. Airbags 88 supplied with air or other fluid by air lines 90 of the front lifting assembly 16 are adapted to move the front arm assembly 82 such that the kingpin 84 is moved in a generally upward and downward direction. Therefore, when in the upward position as shown, for example, in FIG. 1, the front arm assembly 82, together with the kingpin 84, are in position for the semi-truck 22 to move partially under the tongue portion 78 of the tank 14 without contacting the front lifting assembly 16. In such position, the kingpin 84 can be lowered into the kingpin receiver portion 28 of the semi-truck 22. With further downward movement of the front arm assembly 82 against the kingpin receiver portion 28 of the semi-truck 22, the fluid containment system 12 is adapted be moved into the mobile condition depicted in FIG. 5. In such condition, the fluid containment system 12 can easily be transported to another location. Using the front lifting assembly 16 and rear lifting assembly 18, a user can adjust a ride height of the fluid containment system 12 within certain parameters. For example, the fluid containment system 12 of the preferred embodiment has 16″ of adjustable ride height making it suitable for lowering to get under obstacles and raising to get over obstacles.

Although the front and rear lifting assemblies 16, 18 of preferred embodiments comprise pneumatic systems comprising airbags 88, the front and rear lifting assemblies 16, 18 need not comprise pneumatic systems. Rather, other systems known in the art can be used to raise and lower the front and rear portions of the fluid containment system 12. For example, hydraulic systems comprising hydraulic pumps, fluids, rams, scissor lifts, and/other lifts can be used to raise and lower portions of the fluid containment system 12. Other mechanical means of raising and lowering components can also be used. For example, a motorized or hand powered screw jack, scissor jack, or winch and cable system can be incorporated within the fluid containment system 12.

The tank 14 lower floor 39 slopes to permit essentially complete emptying of fluid from the tank 14 either during delivery of fluid to the drilling site or if draining the tank of unused fluid as from a drain (not shown). The tank 14 may be supported on a substantially rectangular frame 37 that includes beams and other frame members welded or otherwise secured together. A lower portion 35 of the frame 37 rests on the ground 24 when the fluid containment system is in the working condition. The front wall 30, rear wall 32, and side walls 36 of the tank 14 of the preferred embodiment are formed from heavy duty corrugated steel. Upright members support sides of the tank 14. The top 34 of the preferred embodiment is formed from heavy steel plate. The frame may include cross-beams spaced along the length of the tank 14, and lengthwise or front-to-back laterally spaced beams under the tank 14.

Although in the preferred embodiment, the front wall 30, rear wall 32, and side walls 36 of the tank 14 are formed from heavy duty corrugated steel, these elements need not be so formed. Rather, the front wall 30, rear wall 32, and side walls 36 of the tank 14 may be formed from straight steel. Also, the material for the front wall 30, rear wall 32, and side walls 36 of the tank 14 may comprise other suitable materials such as other metals or other natural or other manmade materials. For example, other suitable materials that may be used for these and other components of the fluid containment system 12 include aluminum, iron, brass, copper, tin, nickel, plastic, polypropylene, polyethylene, polyvinyl chloride (PVC), Medium-density polyethylene (MDPE), Very-low-density polyethylene (VLDPE), High-molecular-weight polyethylene (HMWPE), high-density polyethylene (HDPE), Ultra-low-molecular-weight polyethylene (ULMWPE), Chlorinated polyethylene (CPE), and the like.

Referring to FIGS. 8-12, an additional embodiment of the fluid containment system 12 is shown. Like numbers are used to designate like elements in the embodiment shown in FIGS. 8-12 as in FIGS. 1-7. As best shown in FIGS. 8 & 12, the stairway 46 of this embodiment comprises the landing 45 a folding lower portion 49 hingedly coupled to a rearmost portion of the angled floor 66 of the fluid containment system 12 with one or more hinges 51. The folding lower portion 49 comprise steps 48. Coupled to the folding lower portion 49 are a plurality of balusters 53 positioned on one or both sides of the folding lower portion 49. The balusters 53 extend outward from one or both sides of the folding lower portion 49 such that when the folding lower portion 49 is in an extended position as shown, for example, in FIG. 12, one or more of the balusters 52 are approximately perpendicular from the folding lower portion 49. Connecting each baluster 52 to a same side adjacent baluster 52 is support member 55. The support member 55 spans from an upper portion of each baluster to an upper portion of the adjacent baluster 52. The support member 55 serves as a hand support when the folding lower portion 49 is in the extended position. In the preferred embodiment, the support member 55 comprises a cable. However, the support member 55 can comprise a cable, chain, rope, or other suitable configuration that permits the folding lower portion 49 to be folded from the extended position shown in FIG. 12 to a stowed position as shown, for example, in FIG. 8. In the preferred embodiment, the balusters 53 are hingedly coupled at a lower end to the folding lower portion 49. An upper end of the support member 55 (as seen when the folding lower portion 49 is in the extended position shown in FIG. 12) may be coupled to the fluid containment system 12 adjacent to a rearmost portion of angled floor 66 or a baluster 53. As shown in FIGS. 10 and 12. a handrail 47 is also provided.

Referring to FIG. 9, the fluid containment system 12 of this embodiment comprises one or more non-pressurized inspection doors 57 and fill lines 62. In preferred embodiments, the fill lines are a 6-inch fill lines 62.

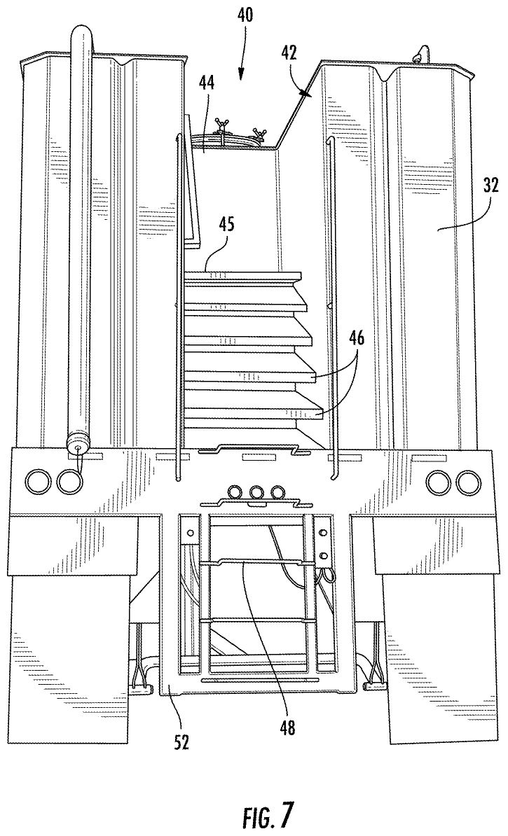

Referring to FIG. 8, the front lifting assembly 16 is configured similarly to that depicted in FIG. 1 such that it is positioned beneath the tongue portion 78 of the tank 14. Likewise, the kingpin sub-system 26 of the front lifting assembly 16 of FIG. 8 comprises the rear arm assembly 80, the front arm assembly 82, the front arm assembly 82 comprising the kingpin 84 adapted to be coupled within the kingpin receiver portion 28 of the semi-truck 22. The front arm assembly 82 and rear arm assembly 80 are coupled to one another via a support assembly 86. The front arm assembly 82 is pivotally coupled to the support assembly 86. The airbags 88 supplied with air or other fluid by air lines 90 (shown in FIG. 6) of the front lifting assembly 16 are adapted to move the front arm assembly 82 such that the kingpin 84 is moved in a generally upward and downward direction as described with respect to the embodiment of FIG. 1. Using the front lifting assembly 16 and rear lifting assembly 18, a user can similarly adjust a ride height of the fluid containment system 12 within certain parameters.

In the embodiment shown in FIG. 8, the fluid containment system 12 comprises a V shaped floor 39 (when viewed from the front or rear) which permits fluid to be collected at a bottom of the V. A first drain 63 permits the lower floor 39 to be drained from the bottom of the V. A header 61 is provided with unions. In this embodiment, the header 61 comprise a 10-inch diameter configuration and the unions are 8-inch unions. A second drain 65 permits a sump to be drained. In the preferred embodiment, the first and second drains 63, 65 are 4-inch drains 63, 65.

The rear suspension system 20 of the embodiments of FIGS. 8-12, though shown only conceptually in the figures is, in these embodiments, identical as that which is shown in FIGS. 1-7. Although in the preferred embodiment, the mobile fluid containment system 12 comprises a single rear axle assembly 70, wheels 72, and tires 74, the mobile fluid containment system 12 can contain more than one rear axle assembly 70, or sets of wheels 72, and tires 74. For example, in some embodiments the mobile fluid containment system 12 comprises a tag axle which may be driven or undriven.

A method of moving a fluid containment system 12 is also provided. The method of a preferred embodiment comprises the steps of providing a fluid containment system 12 at a first location, the fluid containment system 12 comprising a tank 14, a front lifting assembly 16, a rear lifting assembly 18, and a rear suspension system 20; providing a vehicle 22 comprising a receiver portion adapted to receive a male portion of a hitch 84; moving the vehicle receiver portion 28 proximate to the male portion of the hitch 84; using the front lifting assembly 16, coupling the male portion of the hitch 84 to the receiver portion 28; using the front lifting assembly 16, raising a front portion of the tank 14; using the rear lifting assembly 18, raising a rear portion of the tank 14; and using the vehicle 22, moving the fluid containment system 12 from the first location to the second location.

In other embodiments, after the step of using the vehicle 22, moving the fluid containment system 12 from the first location to the second location, the method further comprises the steps of: using the rear lifting assembly 18, lowering the rear portion of the tank 14; using the front lifting assembly 16, uncoupling the male portion of the hitch 84 from the receiver portion 28; using the front lifting assembly 16, lowering a front portion of the tank 14; and moving the vehicle receiver portion 28 away from the male portion of the hitch 84.

In preferred embodiments of the method, the fluid containment system 12 is adapted to be moved by a conventional and commercially available semi-truck 22.

In preferred embodiments of the method, the front lifting assembly 16 comprises a pneumatically-actuated articulating kingpin sub-system 26 which uses leverage to lift the tank 14 off the ground 24 rather than winches or cranes. In the preferred embodiment the front lifting assembly 16 comprises a kingpin 84, a male portion of the cooperative coupling system. However, the front lifting assembly 16 need not comprise a kingpin 84. Rather, the fluid containment system 12 may comprise other cooperative coupling arrangements known in the art. For example, the fluid containment system 12 may comprise a female receiver portion adapted to receive a male portion positioned on the vehicle 22. A trailer ball and hitch arrangement is an example of such a cooperative coupling mechanism. By way of further example, the cooperative coupling arrangement in certain embodiments may be a pintle hitch comprising a hook portion and an eye/ring portion, the eye/ring portion being adapted to be secured with the hook portion.

In preferred embodiments of the method, the rear suspension system 20 comprises an axle assembly 70, wheels 72, and tires 74 structured and arranged to permit the wheels 72 and tires to rotate about the axle assembly 70. The rear suspension system 20 is pivotally coupled to the tank 14 at one or more coupling points 76 such that the rear suspension system 20 may be pivoted upwardly and downwardly between the working condition and the mobile condition.

In an embodiment of the method, the user, using the front lifting assembly 16 and rear lifting assembly 18, can selectively adjust a ride height of the fluid containment system 12 upwardly and downwardly.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

1. A fluid containment system comprising:
a tank adapted to contain fluids, the tank comprising a top, sides, rear, front, and lower floor;
a frame;
a rear suspension system comprising an axle, wheels, and tires, the rear suspension system being structured and arranged to permit the wheels and tires to rotate;
a front lifting assembly;
a cooperative coupling mechanism adapted to couple the fluid containment system to a vehicle;
the front lifting assembly being adapted to lift the front of the tank;
the fluid containment system comprising a working condition and a mobile condition;
a lower portion of the frame resting on a surface when the mobile fluid containment system is in the working condition;
the lower portion of the frame being elevated with respect to the surface when the mobile fluid containment system is in the mobile condition; and
the fluid containment system being adapted to be towed by the vehicle when the cooperative coupling mechanism is coupled to the vehicle and the fluid containment system is in the mobile condition.

2. The fluid containment system of claim 1, the tank comprising a tongue portion comprising a tongue floor, the tongue floor being elevated with respect to the lower portion of the frame.

3. The fluid containment system of claim 2, wherein:
the front lifting assembly is positioned beneath an outside portion of the tongue floor; and
the cooperative coupling mechanism comprises a king pin adapted to be coupled to a king pin receiver of the vehicle.

4. The fluid containment system of claim 1, the front lifting assembly comprising one or more pneumatic bags.

5. The fluid containment system of claim 1, further comprising a rear lifting assembly adapted to lift the rear of the tank.

6. The fluid containment system of claim 5, the rear lifting assembly comprising one or more pneumatic bags.

7. The fluid containment system of claim 1 comprising a rear stairway comprising steps.

8. The fluid containment system of claim 7, the rear stairway further comprising a folding lower portion.

9. The fluid containment system of claim 1 further comprising an angled rear floor, the angled rear floor being elevated with respect to the lower floor and defining a space in which the rear suspension assembly is positioned.

10. A fluid containment system comprising:
a tank adapted to contain fluids, the tank comprising a top, sides, rear, front, and a lower floor;
a frame and a rear stairway;
the rear stairway being positioned within a cutout above an angled floor, the angled floor being elevated with respect to the lower floor and defining a space within which a rear suspension system is positioned;
the rear suspension system comprising an axle, wheels, and tires, the rear suspension system being structured and arranged to permit the wheels and tires to rotate;
a front lifting assembly;
a cooperative coupling mechanism comprising a king pin, the king pin being adapted to be coupled with a king pin receiver of a vehicle;
a rear lifting assembly;
the front lifting assembly being adapted to lift the front of the tank;
the rear lifting assembly being adapted to lift the rear of the tank;
the fluid containment system comprising a working condition and a mobile condition;
a lower portion of the frame resting on a surface when the mobile fluid containment system is in the working condition;
the lower portion of the frame being elevated with respect to the surface when the mobile fluid containment system is in the mobile condition; and
the fluid containment system being adapted to be towed by the vehicle when the cooperative coupling mechanism is coupled to the vehicle and the fluid containment system is in the mobile condition.

11. A method of moving a fluid containment system comprising the steps of:
providing a fluid containment system at a first location, the fluid containment system comprising a tank, a front lifting assembly, a rear suspension system, and a cooperative coupling portion;
the fluid containment system comprising a frame comprising a lower portion resting on a surface;
providing a vehicle comprising a vehicle coupling portion adapted to couple with the cooperative coupling portion;
using the vehicle, moving the vehicle coupling portion proximate to the cooperative coupling portion;
using the front lifting assembly, coupling the cooperative coupling portion to the vehicle coupling portion coupling portion;
using the front lifting assembly, raising a front portion of the tank with respect to the surface; and
using the vehicle, moving the fluid containment system from the first location to a second location.

12. The method of moving a fluid containment system of claim 11, the fluid containment system further comprising a rear lifting assembly and wherein, after the step of using the front lifting assembly, raising a front portion of the tank with respect to the surface, the step of:
using the rear lifting assembly, raising a rear portion of the tank with respect to the surface.

13. The method of moving a fluid containment system of claim 12, the front lifting assembly comprising one or more pneumatic bags.

14. The method of moving a fluid containment system of claim 12, the rear lifting assembly comprising one or more pneumatic bags.

15. The method of moving a fluid containment system of claim 12, wherein, after the step of moving the fluid containment system from the first location the second location, the steps of:
using the front lifting assembly, de-coupling the cooperative coupling portion from the vehicle coupling portion;
using the front lifting assembly, lowering the front portion of the tank with respect to a second surface; and
using the rear lifting assembly, lowering a rear portion of the tank with respect to the second surface.

16. The method of moving a fluid containment system of claim 12, before the step of using the vehicle, moving the fluid containment system from the first location to a second location, the step of:
using the front lifting assembly and rear lifting assembly, selectively adjusting a ride height of the fluid containment system upwardly and downwardly.
